(19) United States
(12) Patent Application Publication
(10) Pub. No.: US 2025/0354807 A1
(43) Pub. Date: Nov. 20, 2025

(54) REGISTRATION DEVICE, REGISTRATION METHOD, AND PROGRAM

(71) Applicant: NIPPON TELEGRAPH AND TELEPHONE CORPORATION, Tokyo (JP)

(72) Inventors: Toshimitsu IZUMI, Tokyo (JP); Yasuhiro MATSUMOTO, Tokyo (JP); Issei WAKUI, Tokyo (JP); Junichiro TAMAMATSU, Tokyo (JP)

(73) Assignee: NIPPON TELEGRAPH AND TELEPHONE CORPORATION, Tokyo (JP)

(21) Appl. No.: 18/866,539

(22) PCT Filed: May 17, 2022
(86) PCT No.: PCT/JP2022/020587

§ 371 Date: Nov. 17, 2024

(51) Int. Cl. G01C 15/00

(52) U.S. Cl. CPC G01C 15/002

(57) ABSTRACT

A registration device (1) includes: one jig (2) including three or more connected spheres disposed in a measurable range from each of a plurality of measurement points inside a structure (20); a measurement unit (11) configured to acquire three-dimensional point cloud data of the structure (20) including the entire jig (2) disposed at the same position in a measurement range from each of the plurality of measurement points using a three-dimensional laser scanner; a first arithmetic unit (12) configured to calculate center coordinates of the three or more spheres included in the jig (2) from the three-dimensional point cloud data and to generate initial alignment data between the plurality of pieces of three-dimensional point cloud data such that the center coordinates match; and a second arithmetic unit (13) configured to generate final alignment data between the plurality of pieces of three-dimensional point cloud data from the initial alignment data using an alignment algorithm.

### TECHNICAL FIELD

The present invention relates to a registration device, a registration method, and a program for performing alignment between a plurality of pieces of three-dimensional point cloud data measured from different measurement points.

### BACKGROUND ART

Conventionally, in order to prevent a fall, a collapse accident, or the like of a covering surface of a structure, deformation such as lifting, peeling, or irregular deformation of the structure on the covering surface is measured. At this time, measurement is performed by a three-dimensional laser scanner, and three-dimensional point cloud data is acquired. Then, the inner space cross section of the structure is accurately measured from the acquired three-dimensional point cloud data. However, in a case in which measurement is performed in a wide range or in a case in which there is a blind spot due to an installation or the like, three-dimensional point cloud data of the entire object cannot be acquired by one measurement. Therefore, a plurality of pieces of three-dimensional point cloud data measured from different measurement points are acquired. Then, in a case in which three-dimensional point cloud data is acquired from a plurality of measurement points, it is necessary to perform registration in order to set each of pieces of three-dimensional point cloud data as data of the same coordinate system. In the present disclosure, registration refers to performing alignment between three-dimensional point cloud data acquired from a plurality of measurement points.

Non Patent Literature 1 describes a technique for selecting high-precision point cloud data in multipoint measurement by a laser scanner. In the technique described in Non Patent Literature 1, a plurality of targets is set in a measurement range, the targets are extracted from three-dimensional point cloud data, and then the pieces of point cloud data are associated via the corresponding targets, thereby performing registration (alignment) between the pieces of three-dimensional point cloud data.

Non Patent Literature 2 describes an efficient point cloud data acquisition technique using a combination of a terrestrial laser scanner (TLS) and a satellite positioning system (Global Navigation Satellite System (GNSS)). In the technique described in Non Patent Literature 2, registration (alignment) of three-dimensional point group data is performed by determining and measuring a measurement position of a measuring instrument such as a three-dimensional laser scanner or a target.

### CITATION LIST

### Non Patent Literature

Non Patent Literature 1: Jun Sakurai and five others, “DEVELOPMENT OF TECHNIQUE FOR SELECTING POINT CLOUD DATA WITH HIGH PRECISION IN MULTIPOINT MEASUREMENT WITH LASER SCANNER”, Journal of Japan Society of Civil Engineers, F3 (Civil Engineering Informatics), Vol 72, No 2, I_209-I_218, 2016.

Non Patent Literature 2: Hiroshi Mori and one other engineer, “EFFICIENT IMPROVEMENT OF POINT CLOUD DATA ACQUISITION AND EXPANSION OF APPLICATION FIELDS INTO ICT PAVEMENT CONSTRUCTION”, Journal of the Japan Society of Civil Engineers, E1 (Paving Engineering Journal, Vol. 24), Vol 75, No 2, I_77-I_85, 2019.

### SUMMARY OF INVENTION

### Technical Problem

However, according to the technology described in Non Patent Literature 1, it is necessary to install a plurality of targets. For this reason, when the range in which measurement is performed is widened, it is necessary to increase the number of targets to be installed depending on the number of times of measurement, and there is a problem that it takes time to install the targets. In addition, when a work space is limited, there is a problem of having to decide where to install a plurality of targets.

On the other hand, the technology of Non Patent Literature 2 requires an expensive measuring instrument including a satellite positioning system (Global Navigation Satellite System (GNSS)) and the like. In addition, the GNSS cannot accurately ascertain a measurement position in a structure having a limited communication environment such as an underground tunnel, and thus cannot perform registration. As described above, the point cloud data acquisition technology using a GNSS is suitable for measurement in a place where a communication environment is good but is not suitable for capturing deformation occurring in a place where a communication environment is limited.

### Solution to Problem

An object of the present invention made in view of such circumstances is to provide a registration device, a registration method, and a program for performing alignment between a plurality of pieces of three-dimensional point cloud data acquired from different measurement points on the basis of three-dimensional coordinates of a jig including three or more connected spheres disposed within a measurement range.

To achieve the aforementioned object, a registration device according to a first embodiment is a registration device for performing alignment between a plurality of pieces of three-dimensional point cloud data, the registration device including: a jig including three or more connected spheres disposed in a measurable range from each of a plurality of measurement points inside a structure; a measurement unit configured to acquire three-dimensional point cloud data of the structure including the jig disposed at the same position in a measurement range from each of the plurality of measurement points using a three-dimensional laser scanner; a first arithmetic unit configured to calculate center coordinates of the three or more spheres included in the jig from the three-dimensional point cloud data and to generate initial alignment data between the plurality of pieces of three-dimensional point cloud data such that the center coordinates match; and a second arithmetic unit configured to generate, from the initial alignment data, final alignment data between the plurality of pieces of three-dimensional point cloud data using an alignment algorithm.

To achieve the aforementioned object, a registration method according to a first embodiment is a registration method for performing alignment between a plurality of pieces of three-dimensional point cloud data, the registration method including: a step of disposing a jig including three or more connected spheres by a measurer in a range where the jig is measurable from each of a plurality of measurement points inside a structure; a step of acquiring, by a registration device, three-dimensional point cloud data of the structure including the entire jig disposed at the same position in a measurement range from each of the plurality of measurement points using a three-dimensional laser scanner; a step of calculating, by the registration device, center coordinates of the three or more spheres included in the jig from the three-dimensional point cloud data; a step of generating, by the registration device, initial alignment data between the plurality of pieces of three-dimensional point cloud data such that the center coordinates match; and a step of generating, by the registration device, final alignment data between the plurality of pieces of three-dimensional point cloud data from the initial alignment data using an alignment algorithm.

To achieve the aforementioned object, a program according to a first embodiment is a program causing a computer to function as the aforementioned registration device.

### Advantageous Effects of Invention

According to the present disclosure, when a structure in a non-GNSS environment is measured by a three-dimensional laser scanner, a target installation work time can be reduced, and at the same time, registration of three-dimensional point cloud data can be efficiently performed.

### BRIEF DESCRIPTION OF DRAWINGS

FIG. 1 is a block diagram showing a configuration example of a registration device according to a first embodiment.

FIG. 2 is a plan view, a front view, and a side view showing a configuration example of a jig including three connected spheres.

FIG. 3 is a diagram showing an example of measurement in a structure.

FIG. 4 is a diagram illustrating coordinate system alignment processing performed by a first arithmetic unit according to the first embodiment.

FIG. 5 is a flowchart showing an example of a registration method executed by the registration device according to the first embodiment.

FIG. 6 is a block diagram showing a configuration example of a registration device according to a second embodiment.

FIG. 7 is a diagram illustrating a planar element set in the second embodiment.

FIG. 8 is a diagram illustrating coordinate system alignment processing performed by a first arithmetic unit according to the second embodiment.

FIG. 9 is a block diagram showing a schematic configuration of a computer serving as a registration device.

### DESCRIPTION OF EMBODIMENTS

Hereinafter, modes for carrying out the present invention will be described in detail with reference to the drawings. The present invention is not limited to the embodiments described below, and various modifications can be made within the scope of the gist of the present invention.

### First Embodiment

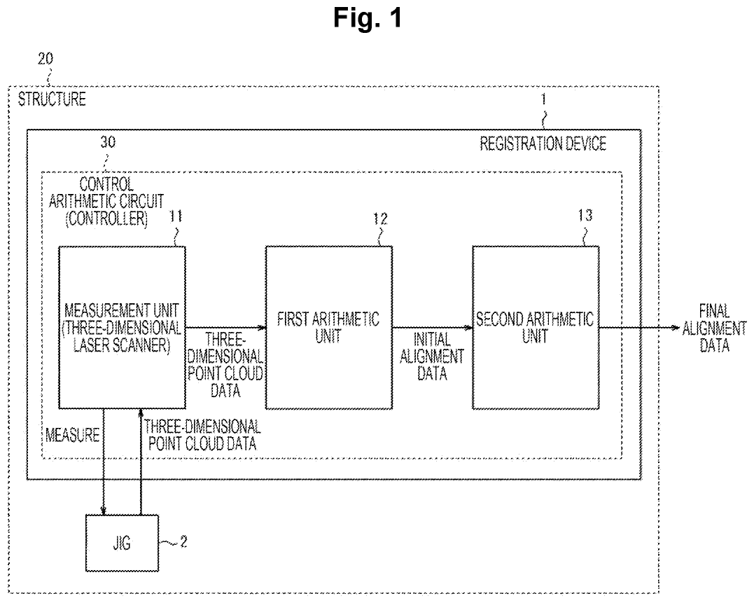

FIG. 1 is a block diagram showing a configuration example of a registration device 1 according to a first embodiment. As shown in FIG. 1, the registration device 1 includes a measurement unit 11, a first arithmetic unit 12, and a second arithmetic unit 13. The registration device 1 performs measurement by a three-dimensional laser scanner from each of a plurality of measurement points to acquire three-dimensional point cloud data from each of the plurality of measurement points, and then performs alignment between the plurality of pieces of three-dimensional point cloud data.

The measurement unit 11, the first arithmetic unit 12, and the second arithmetic unit 13 constitute a control arithmetic circuit (controller) 30. The control arithmetic circuit 30 may be configured as dedicated hardware such as an application specific integrated circuit (ASIC) or a field-programmable gate array (FPGA), may be configured as a processor, or may be configured to include both.

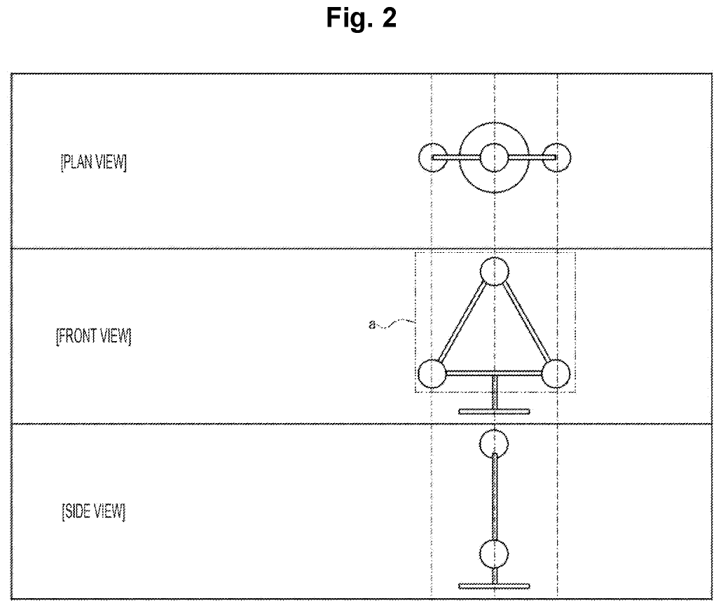

A jig 2 is disposed in a range in which the jig 2 can be measured from each of a plurality of measurement points inside a structure 20 by a measurer. The jig 2 includes three or more connected spheres. In the embodiment described below, it is assumed that the jig 2 includes three connected spheres. When measurement is performed by a three-dimensional laser scanner, one jig 2 is disposed in the measurement range in advance. FIG. 2 is a plan view, a front view, and a side view showing a configuration example of the jig 2 including three connected spheres. As shown in a region a indicated by a broken line in the front view of FIG. 2, the jig 2 includes three spheres disposed to form one plane. The reason for adopting a sphere is that it can be measured as an object having the same shape from a plurality of different measurement points.

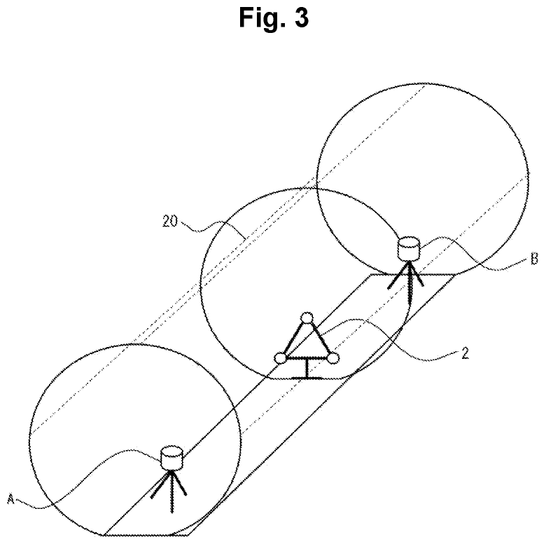

FIG. 3 is a diagram showing an example of measurement in the structure 20 (underground tunnel). As shown in FIG. 3, the jig 2 including the three connected spheres is disposed such that the entire outer shape (three spheres) of the jig 2 falls within the measurement range from a measurement point A and a measurement point B.

Using the three-dimensional laser scanner, the measurement unit 11 acquires three-dimensional point cloud data of the structure 20 in which the entire jig 2 (three or more spheres) including three or more spheres disposed at the same position inside the structure in advance is included in the measurement range from each of a plurality of different measurement points. The measurement unit 11 outputs the three-dimensional point cloud data of the structure 20 acquired from each measurement point to the first arithmetic unit 12.

Three-dimensional point cloud data to be registered needs to include the point cloud data of the jig 2 disposed at the same position measured from each measurement point of the plurality of different measurement points.

The first arithmetic unit 12 calculates center coordinates of the three or more spheres included in the jig 2 from the three-dimensional point cloud data acquired at each measurement point of the plurality of measurement points, and generates initial alignment data in which initial alignment between the plurality of pieces of three-dimensional point cloud data is completed such that the center coordinates match. The first arithmetic unit 12 outputs the initial alignment data to the second arithmetic unit.

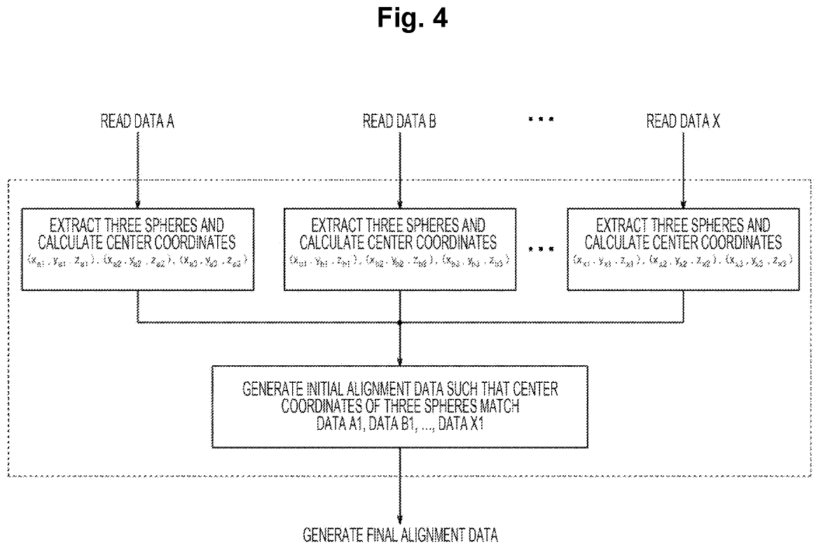

FIG. 4 is a diagram illustrating coordinate system alignment processing performed by the first arithmetic unit 12 according to the first embodiment. As shown in FIG. 4, (i) the first arithmetic unit 12 reads three-dimensional point cloud data (referred to as data A to X) measured at each of a plurality of measurement points A to X. Data reading is repeatedly performed depending on the number of data to be registered. (ii) Next, the first arithmetic unit 12 extracts three spheres from three-dimensional point cloud data to be registered for each of pieces of the data A to X, and calculates the center coordinates of each sphere. (iii) Then, the first arithmetic unit 12 performs initial alignment between the plurality of pieces of three-dimensional point cloud data A to X by aligning the coordinate systems such that the center coordinates of the three spheres of each of pieces of the data A to X match (such that planes formed by the center coordinates of the three spheres overlap with each other) to generate initial alignment data A1 to X1.

The second arithmetic unit 13 generates final alignment data A2 to X2 between the plurality of pieces of three-dimensional point cloud data from the initial alignment data generated by the first arithmetic unit 12 using an alignment algorithm. After the first arithmetic unit 12 performs initial alignment, the second arithmetic unit 13 generates final alignment data A2 to X2 using a three-dimensional point cloud data alignment algorithm such as iterative closest point (ICP). The first arithmetic unit performs initial alignment using only the center coordinates of the spheres, and the second arithmetic unit performs final alignment using all the three-dimensional point cloud data. The reason for performing alignment in two stages is that there is a case in which alignment by a wide-range search using ICP from the beginning leads to a local solution, and the present disclosure adopts a method of applying ICP after performing initial alignment.

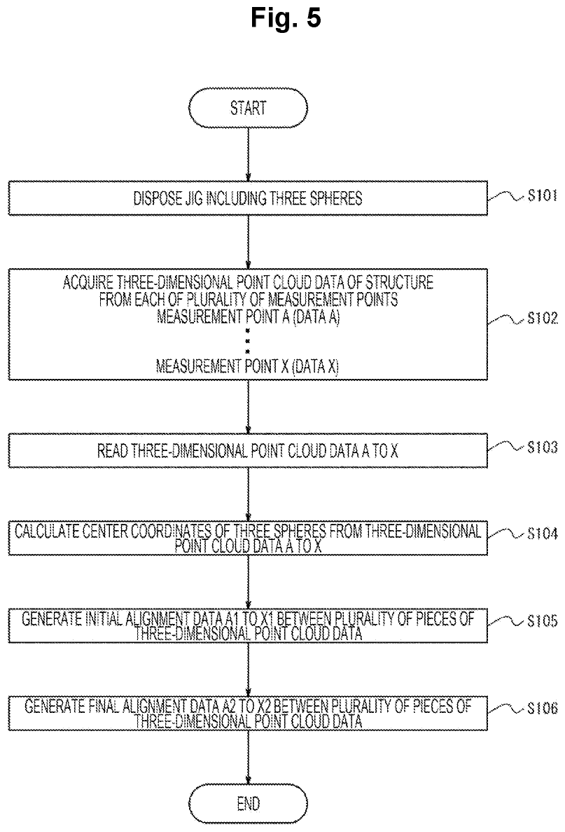

FIG. 5 is a flowchart showing an example of a registration method executed by the registration device 1 according to the first embodiment.

In step S101, a measurer disposes one jig 2 including three connected spheres in a range where the jig 2 can be measured from each measurement point.

In step S102, the measurement unit 11 repeatedly measures the structure 20 in which the entire (three spheres) of the jig 2 disposed at the same position is included in the measurement range from each of a plurality of measurement points A to X using a three-dimensional laser scanner to acquire three-dimensional point cloud data A to X of the structure 20.

In step S103, the first arithmetic unit 12 reads the three-dimensional point cloud data A to X of the structure 20.

In step S104, the first arithmetic unit 12 calculates the center coordinates of the three spheres included in the jig 2 from the three-dimensional point cloud data A to X.

In step S105, the first arithmetic unit 12 generates initial alignment data between the plurality of pieces of three-dimensional point cloud data from the center coordinates of the three spheres calculated for each of the pieces of three-dimensional point cloud data A to X such that the center coordinates of the three spheres match.

In step S106, the second arithmetic unit 13 generates final alignment data A2 to X2 between the plurality of pieces of three-dimensional point cloud data from the initial alignment data using an alignment algorithm.

In a case in which a measurement point is added without changing the range in which the three-dimensional point cloud data is desired to be acquired, measurement at the added measurement point is performed according to the flowchart of FIG. 5 in a state in which the jig 2 is disposed at the same position. In a case in which the range in which the three-dimensional point cloud data is desired to be acquired changes, the position of the jig 2 is moved, and the flowchart of FIG. 5 is executed from the beginning with the first measurement point as the measurement point A.

According to the registration device 1 of the present embodiment, when a structure in a non-GNSS environment is measured by the three-dimensional laser scanner, it is possible to reduce the target installation work time, and at the same time, to efficiently perform registration of three-dimensional point cloud data.

### Second Embodiment

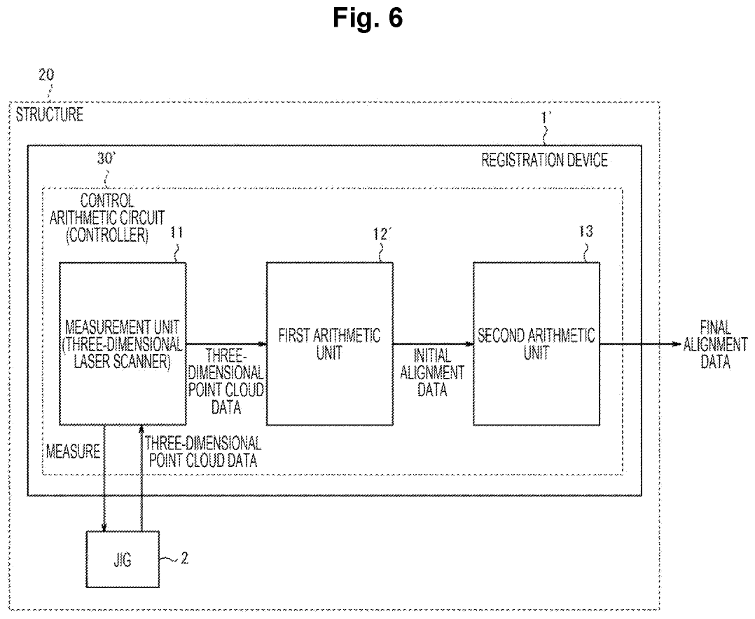

FIG. 6 is a block diagram showing a configuration example of a registration device 1′ according to a second embodiment. As shown in FIG. 6, the registration device 1′ includes a measurement unit 11, a first arithmetic unit 12′, and a second arithmetic unit 13. The registration device 1′ performs alignment between a plurality of pieces of three-dimensional point cloud data. The registration device 1′ according to the present embodiment is partially different from the registration device 1 according to the first embodiment with respect to the processing function of the first arithmetic unit 12′. The same components as those of the first embodiment will be denoted by the same reference signs as those of the first embodiment, and the description thereof will be omitted as appropriate.

The measurement unit 11, the first arithmetic unit 12′, and the second arithmetic unit 13 constitute a control arithmetic circuit (controller) 30′. The control arithmetic circuit 30′ may be configured as dedicated hardware such as an application specific integrated circuit (ASIC) or a field-programmable gate array (FPGA), may be configured as a processor, or may be configured to include both.

After calculating the center coordinates of three or more spheres, the first arithmetic unit 12′ generates initial alignment data between a plurality of pieces of three-dimensional point cloud data such that the coordinates of a planar element set, which is a set of a plurality of points constituting a polygonal plane having the center coordinates as vertices, match.

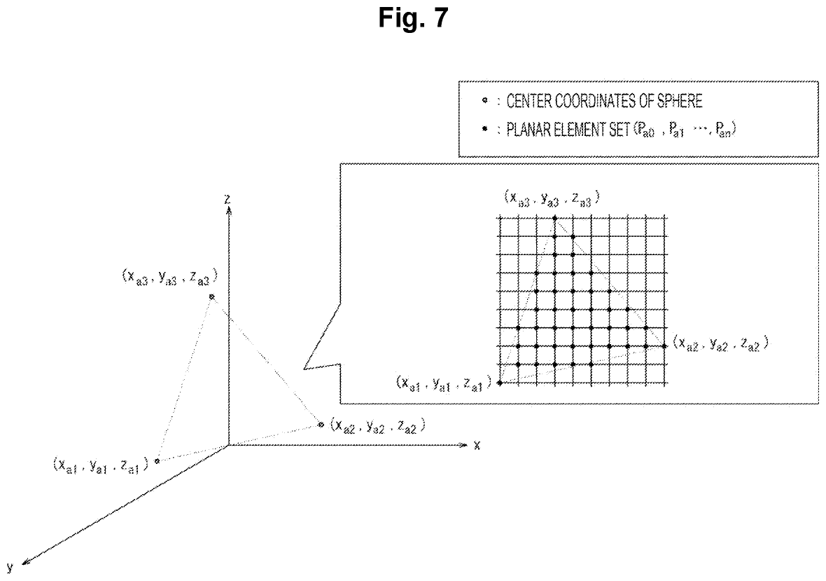

FIG. 7 is a diagram illustrating a planar element set according to the second embodiment. In a case in which the jig 2 includes three connected spheres, the center coordinates of the three spheres are represented by (xa1, ya1, za1), (xa2, ya2, za2), and (xa3, ya3, za3) as shown in FIG. 7. On the other hand, as shown in the balloon of FIG. 7, the planar element set (Pa0, Pa1, . . . , Pan) is not a set of three points of the center coordinates of the three spheres but a set of a plurality of points constituting the plane.

In order to match the coordinate systems of the two planar element sets, a rotation matrix R and a parallel matrix T are obtained using the following formula (1) such that the square error between the planar element sets is minimized.

$$[ Math . 1 ]$$

$$f ( R , T ) = {\sum }_{i = 0}^{n} {‖ {P}_{ai} - ( {RP}_{bi} + T ) ‖}^{2} \qquad ( 1 )$$

In a case in which there are three or more planar element sets (Pc, etc.), the above formula (1) is applied on the basis of the coordinate system calculated by Pa and Pb.

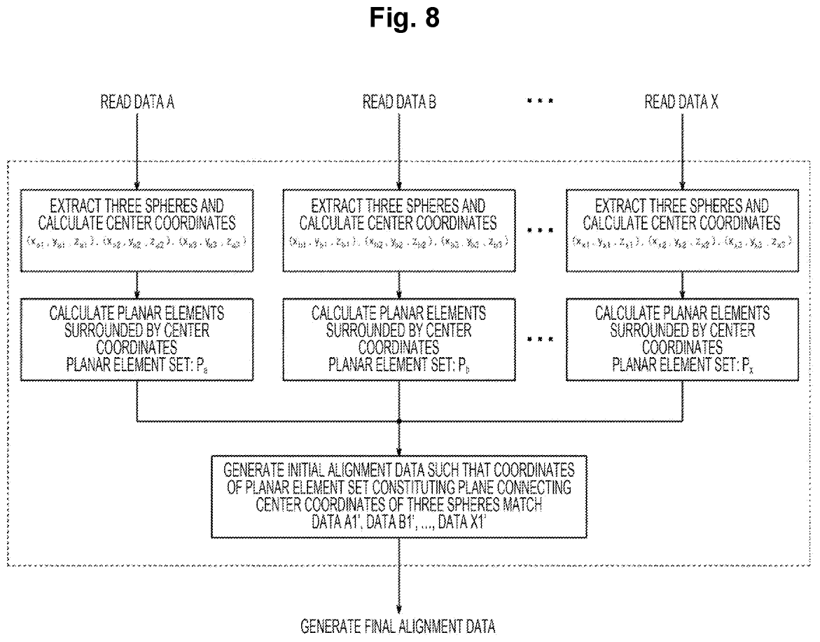

FIG. 8 is a diagram illustrating coordinate system alignment processing performed by the first arithmetic unit 12′ according to the second embodiment. As shown in FIG. 8, (i) the first arithmetic unit 12′ reads three-dimensional point cloud data (referred to as data A to X) measured at each of a plurality of measurement points A to X. Data reading is repeatedly performed depending on the number of data to be registered. (ii) Next, the first arithmetic unit 12′ extracts three spheres from three-dimensional point cloud data to be registered for each of pieces of the data A to X, and calculates the center coordinates of each sphere. (iii) Furthermore, the first arithmetic unit 12′ calculates a planar element set Pa to Px surrounded by the center coordinates of the three spheres. (iv) Finally, the first arithmetic unit 12′ performs initial alignment between the plurality of pieces of three-dimensional point cloud data A to X by matching the coordinate systems such that the center coordinates of the three spheres of each of pieces of data A to X or the coordinates of the planar element set match to generate initial alignment data A1′ to X1′.

According to the registration device 1′ according to the present embodiment, it is possible to expect an increase in the speed of processing for convergence at the time of setting a coordinate system by using a planar element set that is a set of a plurality of points constituting a plane.

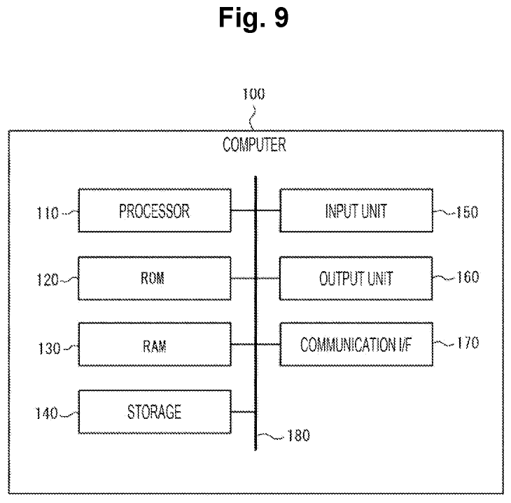

In order to cause the registration devices 1 and 1′ to function, it is also possible to use a computer capable of executing program instructions. FIG. 9 is a block diagram showing a schematic configuration of a computer serving as the registration devices 1 and 1′. Here, the computer serving as the registration devices 1 and 1′ may be a general-purpose computer, a dedicated computer, a workstation, a personal computer (PC), an electronic notepad, or the like. Program instructions may be program code, code segments, or the like for executing a necessary task.

As shown in FIG. 9, the computer 100 includes a processor 110, a read only memory (ROM) 120, a random access memory (RAM) 130, and a storage 140 as storage units, an input unit 150, an output unit 160, and a communication interface (I/F) 170. The respective components are connected to each other via a bus 180 such that they can communicate.

The ROM 120 stores various programs and various types of data. The RAM 130 temporarily stores programs or data as a work area. The storage 140 includes a hard disk drive (HDD) or a solid state drive (SSD), and stores various programs including an operating system and various types of data. In the present disclosure, a program according to the present disclosure is stored in the ROM 120 or the storage 140.

Specifically, the processor 110 is a central processing unit (CPU), a micro processing unit (MPU), a graphics processing unit (GPU), a digital signal processor (DSP), a system on a chip (SoC), or the like and may be constituted by the same or different types of plurality of processors. The processor 110 reads a program from the ROM 120 or the storage 140 and executes the program using the RAM 130 as a work area to perform control of each of the above-described configurations and various types of arithmetic processing. Note that at least a part of these processing details may be realized by hardware.

The program may be recorded in a recording medium readable by the registration devices 1 and 1′. Such a recording medium can be installed in the registration devices 1 and 1′ if it is used. Here, the recording medium on which the program is recorded may be a non-transitory recording medium. Examples of the non-transitory recording medium include, but are not limited to, a CD-ROM, a DVD-ROM, a Universal Serial Bus (USB) memory, and the like. In addition, the program may be downloaded from an external device via a network.

With regard to the above embodiments, the following supplements are further disclosed.

### (Supplement 1)

A registration device for performing alignment between a plurality of pieces of three-dimensional point cloud data, the registration device including:
a jig including three or more connected spheres disposed in a measurable range from each of a plurality of measurement points inside a structure; and
a controller configured to acquire three-dimensional point cloud data of the structure including the entire jig disposed at the same position in a measurement range from each of the plurality of measurement points using a three-dimensional laser scanner, to calculate center coordinates of the three or more spheres included in the jig from the three-dimensional point cloud data, to generate initial alignment data between the plurality of pieces of three-dimensional point cloud data such that the center coordinates match, and to generate, from the initial alignment data, final alignment data between the plurality of pieces of three-dimensional point cloud data using an alignment algorithm.

### (Supplement 2)

The registration device according to supplement 1, wherein after calculating the center coordinates of the three or more spheres, the controller generates the initial alignment data between the plurality of pieces of three-dimensional point cloud data such that coordinates of a planar element set, which is a set of a plurality of points constituting a polygonal plane having the center coordinates as vertices, match.

### (Supplement 3)

A registration method for performing alignment between a plurality of pieces of three-dimensional point cloud data, the registration method including:
disposing a jig including three or more connected spheres by a measurer in a range where the jig is measurable from each of a plurality of measurement points inside a structure; and
by a registration device, acquiring three-dimensional point cloud data of the structure including the entire jig disposed at the same position in a measurement range from each of the plurality of measurement points using a three-dimensional laser scanner, calculating center coordinates of the three or more spheres included in the jig from the three-dimensional point cloud data, generating initial alignment data between the plurality of pieces of three-dimensional point cloud data such that the center coordinates match, and generating, from the initial alignment data, final alignment data between the plurality of pieces of three-dimensional point cloud data using an alignment algorithm.

### (Supplement 4)

A non-transitory storage medium storing a program executable by a computer, the non-transitory storage medium storing a program that causes the computer to function as the registration device according to supplement 1 or 2.

Although the above-described embodiments have been described as representative examples, it is apparent to those skilled in the art that many modifications and substitutions can be made within the spirit and scope of the present disclosure. Accordingly, it should not be understood that the present invention is limited by the above embodiment, and various modifications or changes can be made within the scope of the claims. For example, a plurality of configuration blocks described in the configuration diagram of the embodiment can be combined into one, or one configuration block can be divided.

### REFERENCE SIGNS LIST

1, 1′ Registration device
2 Jig (jig including three or more connected spheres)
11 Measurement unit (three-dimensional laser scanner)
12, 12′ First arithmetic unit
13 Second arithmetic unit
Structure
30, 30′ Control arithmetic unit (controller)
100 Computer
110 Processor
120 ROM
130 RAM
140 Storage
150 Input unit
160 Output unit
170 Communication interface (I/F)
180 Bus

1. A registration device for performing alignment between a plurality of pieces of three-dimensional point cloud data, the registration device comprising:
a jig including three or more connected spheres disposed in a measurable range from each of a plurality of measurement points inside a structure;
a measurement unit configured to acquire three-dimensional point cloud data of the structure including the entire jig disposed at the same position in a measurement range from each of the plurality of measurement points using a three-dimensional laser scanner;
a first arithmetic unit configured to calculate center coordinates of the three or more spheres included in the jig from the three-dimensional point cloud data and to generate initial alignment data between the plurality of pieces of three-dimensional point cloud data such that the center coordinates match; and
a second arithmetic unit configured to generate, from the initial alignment data, final alignment data between the plurality of pieces of three-dimensional point cloud data using an alignment algorithm.

2. The registration device according to claim 1, wherein after calculating the center coordinates of the three or more spheres, the first arithmetic unit generates the initial alignment data between the plurality of pieces of three-dimensional point cloud data such that coordinates of a planar element set, which is a set of a plurality of points constituting a polygonal plane having the center coordinates as vertices, match.

3. A registration method for performing alignment between a plurality of pieces of three-dimensional point cloud data, the registration method comprising:
disposing a jig including three or more connected spheres by a measurer in a range where the entire jig is measurable from each of a plurality of measurement points inside a structure;
acquiring, by a registration device, three-dimensional point cloud data of the structure including the entire jig disposed at the same position in a measurement range from each of the plurality of measurement points using a three-dimensional laser scanner;
calculating, by the registration device, center coordinates of the three or more spheres included in the jig from the three-dimensional point cloud data;
generating, by the registration device, initial alignment data between the plurality of pieces of three-dimensional point cloud data such that the center coordinates match; and
generating, by the registration device, final alignment data between the plurality of pieces of three-dimensional point cloud data from the initial alignment data using an alignment algorithm.

4. (canceled)

5. The registration method according to claim 3, wherein after calculating the center coordinates of the three or more spheres, the initial alignment data between the plurality of pieces of three-dimensional point cloud data is generated such that coordinates of a planar element set, which is a set of a plurality of points constituting a polygonal plane having the center coordinates as vertices, match.

6. A computer-readable non-transitory recording medium storing computer-executable program instructions that when executed by a processor cause a computer to execute a registration method comprising:
disposing a jig including three or more connected spheres by a measurer in a range where the entire jig is measurable from each of a plurality of measurement points inside a structure;
acquiring, by a registration device, three-dimensional point cloud data of the structure including the entire jig disposed at the same position in a measurement range from each of the plurality of measurement points using a three-dimensional laser scanner;
calculating, by the registration device, center coordinates of the three or more spheres included in the jig from the three-dimensional point cloud data;
generating, by the registration device, initial alignment data between the plurality of pieces of three-dimensional point cloud data such that the center coordinates match; and
generating, by the registration device, final alignment data between the plurality of pieces of three-dimensional point cloud data from the initial alignment data using an alignment algorithm.

7. The computer-readable non-transitory recording medium according to claim 6 wherein the registration method further comprises:
wherein after calculating the center coordinates of the three or more spheres, the initial alignment data between the plurality of pieces of three-dimensional point cloud data is generated such that coordinates of a planar element set, which is a set of a plurality of points constituting a polygonal plane having the center coordinates as vertices, match.
